(19) United States
(12) Patent Application Publication
(10) Pub. No.: US 2008/0029932 A1
(43) Pub. Date: Feb. 7, 2008

(54) MOLDING MACHINE WITH PLATEN-ATTACHED HOT RUNNER MANIFOLD

(75) Inventors: John R. Zietlow, Spring Lake, MI (US); William B. Andrews, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/830,400

(22) Filed: Jul. 30, 2007

Related U.S. Application Data
(60) Provisional application No. 60/835,058, filed on Aug. 2, 2006.

(51) Int. Cl. B29C 45/22

(52) U.S. Cl. 264/319; 425/562; 425/570; 425/574; 425/588; 425/595

(57) ABSTRACT

An apparatus includes an injection molding machine, a hot runner apparatus attached to the molding machine, and a mold defining a part cavity. The mold is attached to the molding machine and operably engages the hot runner apparatus. The hot runner apparatus has secondary nozzles that engage respective sprue assemblies on the mold for communicating melted plastic material to the mold cavity. Each sprue assembly includes a movably mounted sprue and a stress-reducing mechanism with spring washers that support the sprue to provide sufficient force to eliminate leaking at abutting contact surfaces against the secondary nozzles, but that allow limited movement of the sprue to reduce excessive stress focused on the respective sprues. Since the stress-reducing mechanism is located in the mold, each stress-reducing mechanism can be tailored to the particular needs of that particular mold and the particular melted material being processed.

This claims benefit of a provisional application under 35 U.S.C. §119(e), Ser. No. 60/835,058, filed Aug. 2, 2006, entitled MOLDING MACHINE WITH PLATEN-ATTACHED HOT RUNNER MANIFOLD.

### BACKGROUND

The present invention relates to hot runner systems for injection molding machines and molds. More specifically, it relates to an injection molding machine with platen-attached hot runner manifold and mold for engaging the platen and hot runner manifold, with the hot runner manifold and the mold being configured to both minimize leakage of melted plastic material while also minimizing stress from the compressive stresses caused by the molding machine clamping against the mold.

Molding dies often include hot runner systems with heaters that keep a stream of melted plastic material in a fluid heated state ready for injection, while previously injected plastic cools in the cavity of a mold. However, mold components for hot runner systems are expensive to purchase and maintain, and further typically a hot runner system is attached to each set of molding dies . . . which is an expensive capital investment. Further, these mold-attached hot runner systems require time to hook up and heat up, thus adding considerably to mold die change times.

Imaida U.S. Pat. No. 5,225,211 discloses a hot runner device fixed directly to a molding machine, allowing the same runner device to “be commonly used for different types of molds” (see last line of abstract). The hot runner device in Imaida '211 has hot runner components (see the structure around “torpedoes” 25) defining multiple outputs for communicating melted plastic material into the mold at multiple sites. (See FIG. 2.) However, as an injection molding machine clamps against the mold in Imaida '211 to hold the mold halves tight against each other, high compressive stresses are generated along the components forming the flow channel at the multiple outputs. It is difficult to control the level of stress at these multiple drop locations, since there must be sufficient pressure at all abutting contact locations to prevent leakage of the highly-pressurized melted plastic material at each abutting contact location, yet there must be low enough contact pressure to prevent damage which will result if the entire clamping force is communicated through the components defining the output locations. This problem is aggravated since stack-up dimensions change as a mold and hot runner system are heated, and further change as the mold and hot runner system are repeatedly heated and cooled during a molding cycle, and further change as components wear during use. This problem also becomes dramatically more difficult when there is an increasing number of (multiple) output locations, such as four or more, due additive variations in stacked tolerances of those components.

Gessner U.S. Pat. No. 5,374,182 and Jenko U.S. Pat. No. 6,555,044 disclose hot runner systems incorporating pneumatic shut-offs for controlling flow of molten polymeric material, and incorporating stress-reducing mechanisms for reducing stress on mold components. In particular, Gessner '182 discloses a system incorporating a flex member (e.g., spring washer 8, FIG. 1) and Jenko '044 discloses a system incorporating a flex member (e.g., spring washer 118, FIGS. 2, 4) that take up some of the compressive forces when a molding die set is clamped under high pressure between the stationary and movable platens of an injection molding machine. However, Gessner and Jenko teach that there is an advantage to having the flex member in their hot runner device, in order to reduce components and minimize expense and capital investment. But the stress-reducing mechanisms of Gessner and Jenko cannot be adapted for particular molds. Instead, they can only be adapted for the “worst case” mold. Specifically, the particular flex member used in the hot runner systems of Gessner and Jenko have to be strong enough to prevent leakage of melted pressurized plastic on all molds (since the flex members are part of the hot runner device), including the “worst case” mold (i.e., the one that requires a very high strength flex member) and the “best case” mold (i.e., the one that requires the lowest strength flex member). As a result, the “best case” mold experiences an unnecessarily high level of stress from clamping pressure of the injection molding machine. The difference between a “worst case” mold and a “best case” mold may be based on a number of different factors, such as the number and depth of injection site locations in the mold, different injection pressures that are required (due to such things as part requirements, runner lengths, dimensional considerations, and difficulty in filing the mold cavity to form a complete part), different melted polymeric materials (i.e., different viscosities and flow characteristics), and/or the overall material flow and packing pressures required to form good parts in the various mold cavities.

Thus, an innovative improvement is desired.

### SUMMARY OF THE PRESENT INVENTION

In one aspect of the present invention, an apparatus includes an apparatus comprising an injection molding machine, a hot runner apparatus, and a mold. The injection molding machine includes a stationary platen, a movable platen, and a device for injecting melted plastic material through a primary nozzle. The hot runner apparatus is attached to the stationary platen, and has an inlet for receiving the melted plastic material from the primary nozzle and has at least two secondary nozzles defining outlets and further has at least one elongated passage for communicating the melted plastic material from the primary nozzle to the at least two secondary nozzles. The mold with mating mold halves defines a part cavity and further defines a passage for communicating the melted plastic material into the cavity. One of the mold halves further includes at least two sprue subassemblies that matably releasably engage associated ones of the secondary nozzles so that the mold can be removed while the hot runner apparatus remains attached to the stationary platen. The at least two sprue subassemblies each include a movably-mounted sprue and a stress-reducing mechanism operably supporting the sprue, with the stress-reducing mechanism supporting the sprue with sufficient force to prevent leakage of the melted plastic material at abutting surfaces where the sprue engages an associated one of the secondary nozzles, but the stress-reducing mechanism allowing limited movement of the sprue to reduce stress on the sprue when the molding machine is compressively clamping against the mold to hold the mold halves together, the stress-reducing mechanism being designed to provide a strength suitable for causing non-leak abutting contact of the sprues with the associated secondary nozzles.

In another aspect of the present invention, an apparatus is adapted for use in an injection molding machine having a stationary platen, a movable platen, and a device for injecting melted plastic material through a primary nozzle. The apparatus comprises a hot runner apparatus adapted for attachment to the stationary platen, the hot runner apparatus having an inlet for receiving the melted plastic material from the primary nozzle and having at least two secondary nozzles defining outlets and having at least one elongated passage for communicating the melted plastic material from the primary nozzle to the at least two secondary nozzles. The apparatus further includes at least two molds, each mold having mating mold halves defining a part cavity and defining a passage for communicating the melted plastic material into the cavity, with one of the mold halves further including at least two sprue subassemblies that matably releasably engage the secondary nozzles so that the mold can be removed while the hot runner apparatus remains attached to the stationary platen. Each of the at least two sprue subassemblies of each mold includes a movably-mounted sprue and a stress-reducing mechanism supporting the sprue. The stress-reducing mechanism supports the respective sprue with sufficient force to prevent leakage of the melted plastic material at abutting surfaces where the sprue engages an associated one of the secondary nozzles, but the stress-reducing mechanism allows limited movement of the sprue to reduce stress on the sprue when the molding machine is compressively clamping against the mold to hold the mold halves together.

In another aspect of the present invention, a mold is provided that is adapted for use in an injection molding machine having a stationary platen, a movable platen, and a device for injecting melted plastic material through a primary nozzle, and that is adapted for use with a hot runner apparatus attached to the stationary platen, the hot runner apparatus having an inlet for receiving the melted plastic material from the primary nozzle and having at least two secondary nozzles defining outlets and having at least one elongated passage for communicating the melted plastic material from the primary nozzle to the at least two secondary nozzles. The mold includes mating mold halves defining a part cavity and defining a passage for communicating the melted plastic material into the cavity, with one of the mold halves further including at least two sprue subassemblies that are adapted to matably releasably engage the secondary nozzles so that the mold can be removed while the hot runner apparatus remains attached to the stationary platen. The at least two sprue subassemblies each include a movably-mounted sprue and a stress-reducing mechanism supporting the sprue, the stress-reducing mechanism supporting the sprue with sufficient force to prevent leakage of the melted plastic material at abutting surfaces where the sprue engages an associated one of the secondary nozzles, but the stress-reducing mechanism allowing limited movement of the sprue to reduce stress on the sprue when the molding machine is compressively clamping against the mold to hold the mold halves together.

In another aspect of the present invention, a method comprises steps of providing an injection molding machine having a stationary platen, a movable platen, and a primary nozzle for injecting molten plastic; providing a hot runner apparatus with an inlet for receiving melted plastic material from the primary nozzle and having a plurality of secondary nozzles for further communicating the melted plastic material; and providing first and second molds each defining a part cavity, a passage to the part cavity, and sprue assemblies for engaging the secondary nozzles to receive the melted plastic material for communication to the part cavity, the sprue assemblies including a movably-mounted sprue and a stress-reducing mechanism supporting the sprue for limited movement. The method includes attaching the hot runner apparatus to the stationary platen; removably attaching the first mold to the stationary platen with the sprue assemblies of the first mold engaging the secondary nozzles, and with the stress-reducing mechanism in the first mold supporting the movably-mounted sprues with a first amount of force for optimal non-leak abutting contact; removing the first mold from the injection molding machine while leaving the hot runner apparatus attached to the stationary platen; and removably attaching the second mold to the stationary platen with the sprue assemblies of the second mold engaging the secondary nozzles, and with the stress-reducing mechanism in the second mold supporting the movably-mounted sprues with a second amount of force for optimal non-leak abutting contact.

In one aspect, the present invention reduces an initial capital investment when purchasing new molding dies in the future, since a common hot runner manifold is used. However, at the same time, the present invention reduces die change times while still allowing molding dies to be optimally configured for a best material flow.

These and other aspects, objects, and features of the present invention will be understood and appreciated by those skilled in the art upon studying the following specification, claims, and appended drawings.

### BRIEF DESCRIPTION OF DRAWINGS

FIG. 1 is a cross-sectional view of a mold and injection molding machine.

FIGS. 2-3 are cross-sectional views of alternative constructions.

FIGS. 4-5 are cross-sectional views of a second alternative construction, FIG. 4 showing a valve pin that is closed, and FIG. 5 showing a similar valve pin that is open.

FIGS. 6-7 are cross-sectional and perspective views of the construction in FIG. 4, but with the mold halves in an open position.

FIGS. 8-9 are perspective cross-sectional views with component eliminated to better show the interfacing components during a mold change.

### DETAILED DESCRIPTION OF PREFERRED EMBODIMENTS

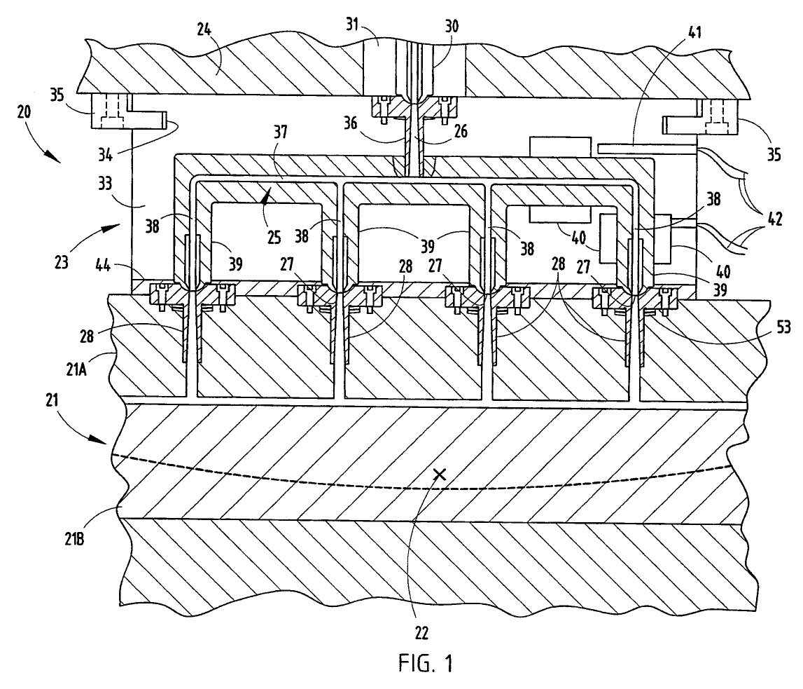

An apparatus 20 (FIG. 1) includes an injection molding machine (well known in the art), a mold 21 with die halves 21A and 21B defining a part cavity 22, and a hot runner apparatus 23 (also called a “manifold” herein) attached to a stationary platen 24 of the molding machine and positioned between the die half 21A of the mold 21 and the platen 24. The hot runner apparatus 23 has an elongated passage 25 for communicating molten plastic from a primary nozzle 30 on the injection molding machine into its inlet opening 26 and through passage 25 to the outlet openings 27 (four being shown) that open into the mold sprues 28 leading to cavity 22 in the mold 21. The hot runner apparatus 23 includes heaters (not shown, but well known in the art) that keep the melted plastic material in a hot/flowable condition while waiting for the injection cycle of the molding machine to inject the melted plastic material into the part cavity of the mold. The hot runner apparatus 23 is configured to remain with the stationary platen 24 even when the mold 21 is removed from the injection molding machine. Thus, a second mold (similar to mold 21 but having a differently shaped cavity) can be installed in the injection molding machine while leaving the hot runner apparatus attached to the stationary platen.

Injection molding machines are well known in the art and need not be described herein. For example, many such machines include a screw barrel with a nozzle 30 extending through an aperture 31 in the stationary platen 24 for injecting molten plastic into a mold cavity. The injection molding machine includes a shut-off and other controls for operating the screw to control flow of the molten plastic material being injected.

The hot runner apparatus 23 includes a manifold block 33 with a channel or notches 34 configured to allow it to be fixedly attached to the stationary platen 24 by clamps and die-holders 35. A nozzle-engaging sprue 36 engages the head of the nozzle tip, and includes a passage that extends to the main passage 25. The passage 25 includes first portions 37 that extend laterally and also second “drop” portions 38 and drop tips 39 that extend “forwardly” toward the mold cavity 22 into contact with the secondary sprues 28 (also called “mold sprues” herein) in the mold 21. Notably, the illustrated heat sources (items 40 & 41) are shown as heater bands 40 and rods 41, however, it is contemplated that various heating methods can be applied. Thus, heating sources are not limited to those shown in this illustration. Power and control wires 42 leading away from the heaters (only a few being shown), are used to keep plastic in the sprue 36 and passage 25 in a molten heated state.

A magnetic plate 44 can be incorporated into a face of the hot runner block 33 (or simply coupled to its face) in order to hold the mold 21 on the stationary platen 24 and/or to the hot runner apparatus 23. By selectively controlling the magnetic attraction, the mold 21 can be quickly attached (or released) to speed die change. Such devices are commercially available and need not be described in detail for an understanding by a person skilled in this art.

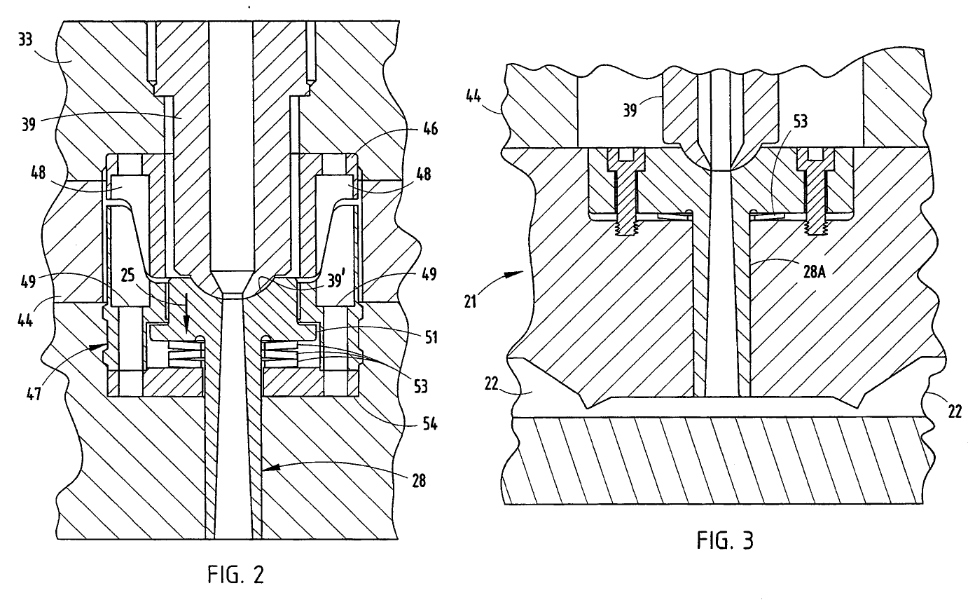

It is important that molten plastic not leak out of the outlet openings 27 that open into the mold sprues 28 leading to cavity 22 in the mold 21, even when the melted plastic material is highly pressurized due to forces from the injecting device in the injection molding machine. Notably, the injection force on the plastic can be relatively high (both during the plastic injection phase, and also during the pack-out phase when replacement plastic is pumped into the mold cavity as the plastic in the cavity cools and shrinks). Further, alignment of the drop tips 39 with the mold sprues 28 is important to prevent weakly sealed areas where the pressurized melted plastic will leak and squirt out. For this purpose, the hot runner apparatus 23 is provided with an alignment bushing 46 (FIG. 2) defining a ramped pocket at each drop location, and the mold sprues 28 are provided with a mating alignment bushing 47 for engaging the pocket of the bushing 46 for improved accurate alignment upon installation of the mold 21 to the stationary platen 24. Bores 48 and 49 extend through the bushings 46 and 47 and provide locations for screws to attach the bushings 46 and 47 to the respective hot runner block 33 and mold 21.

The drop tip 39 (FIG. 2) includes a forwardly-protruding convex tip surface shaped to matingly sealingly engage a mating concave surface 39 on the tip of the mold sprue 28. The mold sprue 28 includes an enlarged head 51 and is supported for limited movement in direction 52 by a plurality of wave washers 53 (also called “spring washers” and/or Bellville springs) retained by a cap plate 54 to the bushing 47. The wave washers 53 (arranged in inverted positions in their stacked sequence) provide enough extending force on the mold sprues 28 so that a seal is made to prevent leak-out of pressurized melted plastic flowing from the drop outlets 38 into the mold sprues 28. It is noted that when multiple drop locations are provided, it is extremely difficult to control a relative “perfect” position of all components, such that leaks of plastic cannot be avoided, except by a system that takes up tolerance variations and maintains pressure at the sealed abutting surfaces. It is contemplated that additional (or fewer) wave washers 53 can be used, and/or that they can all be arranged in a similar orientation (instead of the alternating sequence shown in FIG. 2 . . . for example, see FIG. 4).

FIG. 3 shows a second arrangement of a drop tip 39 to mold sprue 28A connection. In the arrangement of FIG. 3, alignment bushings are not required, and further only a single wave washer 53 is required. Further, the mold sprue 28A deposits melted plastic near to gates into the mold cavity. It is noted that different wave washer with different strengths can be used, so that the resistive force provided at each secondary nozzle location for injecting plastic material into the mold can be a different strength.

### Modification

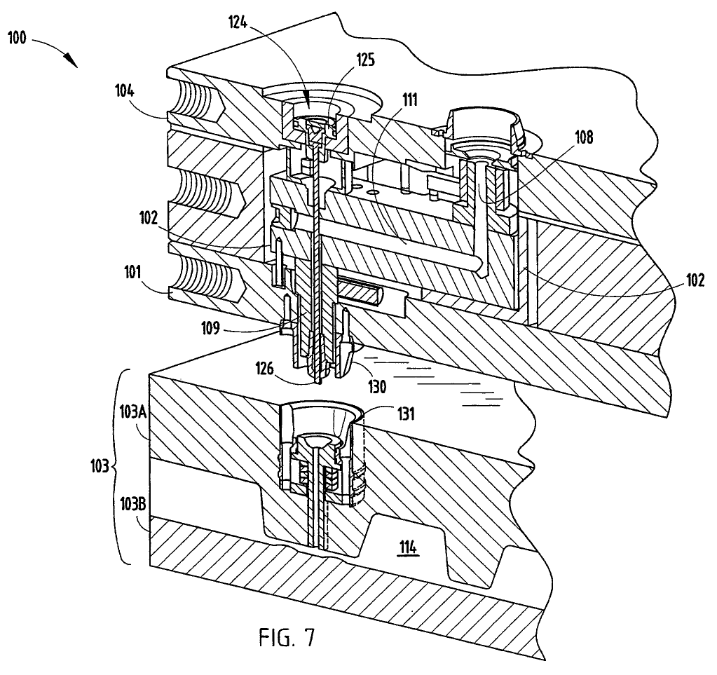

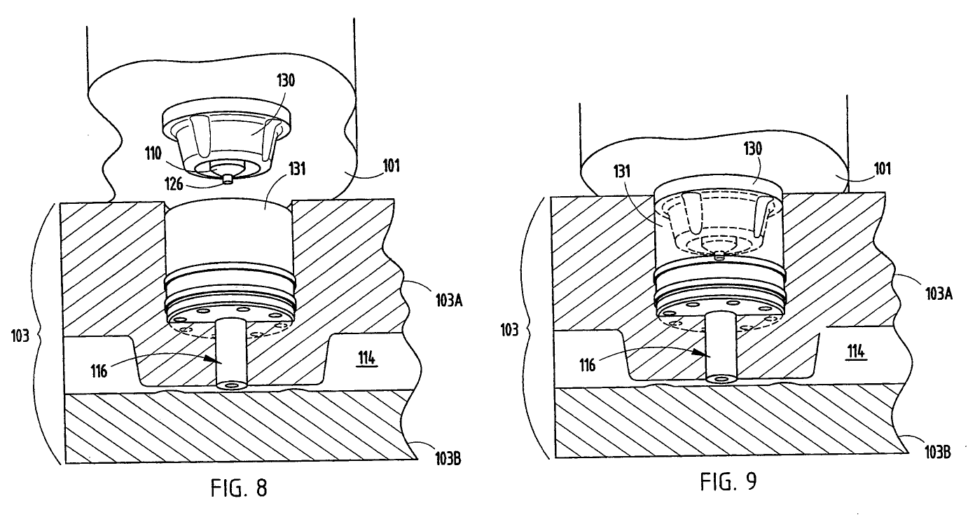

A modified arrangement is shown in FIGS. 4-9 using similar and identical components to those previously disclosed and discussed above. However, the present arrangement adds shut valving for improved control of flow of the melted plastic material.

The modified apparatus 100 (FIGS. 4 and 6) includes an injection molding machine (well known in the art) with magnetic mold-retention plate 101, a hot runner apparatus 102, and a mold 103. The injection molding machine includes a stationary platen 104, a movable platen 105, and an injection device 106 for injecting melted plastic material through a primary nozzle 107. The hot runner apparatus 102 is attached to the stationary platen 104 by known means, such as with threaded bolts and clamps. The hot runner apparatus 102 has an inlet device 108 for receiving the melted plastic material from the primary nozzle 107 and has at least two secondary nozzles 109 defining outlets at tips 110 and further has at least one elongated passage 111 for communicating the melted plastic material from the primary nozzle 107 to the at least two secondary nozzles 109. It is noted that the plastic material may be any of a variety of different polymeric materials, and may include fillers and internal reinforcers, such as chopped fiberglass, talc, and other fillers.

The mold 103 has mating mold halves 103A and 103B that define therebetween a part cavity 114 and further define a passage 115 (often called a “runner”) for communicating the melted plastic material into the cavity 114. One of the mold halves 103A further includes at least two sprue subassemblies 116 that matably releasably engage the secondary nozzles 109. By this arrangement, the mold 103 can be removed while the hot runner apparatus 102 remains attached to the stationary platen 104. The at least two sprue subassemblies 116 each include a movably-mounted secondary sprue 117 and a stress-reducing mechanism 118 (i.e. one or more Bellville spring washers or wave washers or springs) supporting the associated sprue 117. The illustrated springs are positioned on a long neck 117A of the sprue 117 and abut an enlarged end 117B of the sprue 117 . . . and further are held in place by a cover plate 122. Specifically, the stress-reducing mechanism 118 supports the sprue 117 with sufficient force to prevent leakage of the melted plastic material at abutting surfaces at a tip of the sprue 117 where the sprue 117 abuttingly engages an associated one of the secondary nozzles 109. However, the stress-reducing mechanism 118 allows limited movement of the sprue 117 to reduce stress on the sprue 117 and stress on associated components in the mold 103 when the molding machine is compressively clamping against the mold 103 to hold the mold halves 103A and 103B together.

Notably, each of the mold 103 of FIG. 4, the mold of FIG. 2, and the mold of FIG. 3 have different numbers and arrangements of wave washers (also called “spring washers” or Bellville washers) in their stress-reducing mechanisms for reducing stress on the respective secondary sprues. It is also contemplated that the spring washers themselves can be different strengths. Thus, the resistive forces provided by the stress-reducing mechanisms can be specifically tailored to individual drop sites and sprue locations, thus providing sufficient force to cause non-leaking abutting contact, while also minimizing stress from compressive forces of the molding machine on the related mold components.

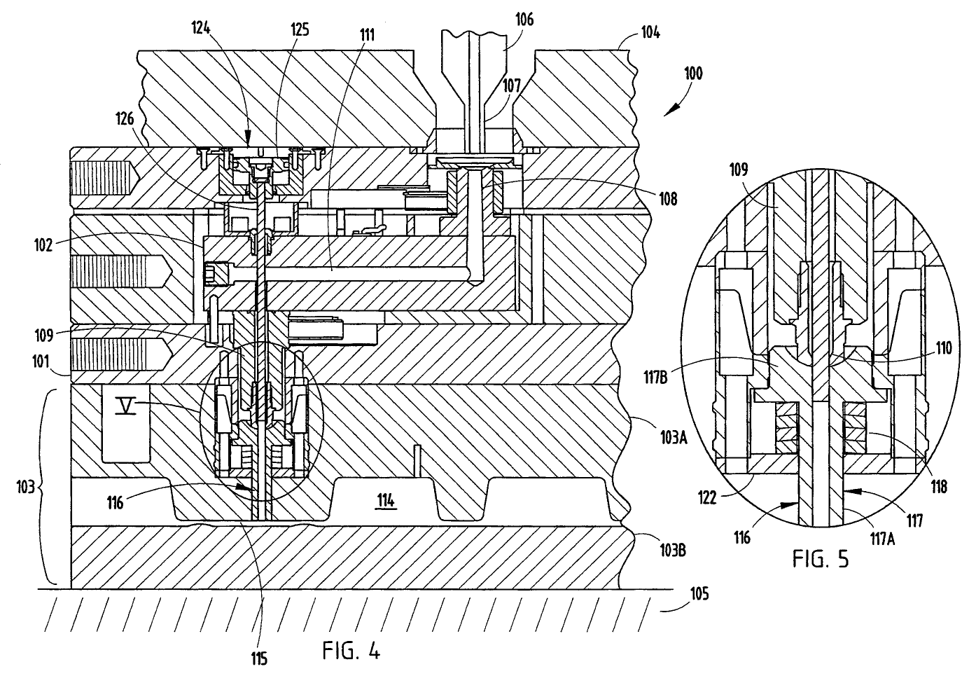

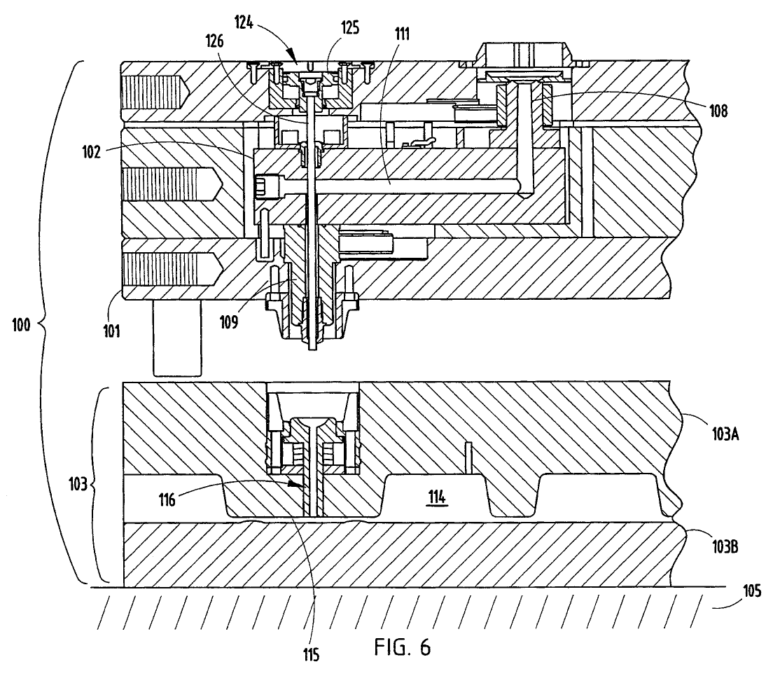

The mold 103 (FIG. 4) includes a pin/valve flow shut off structure 124 for controlling material flow through the secondary sprue 117. A variety of such constructions are known in the art and are commercially available. The illustrated arrangement includes a pneumatic (or hydraulic) actuator 125 connected to a pin 126 that extends through a center of the sprue 117. Compressed air is used to motivate the actuator 125 and hence pin 126 between a retracted position (FIG. 4) that allows melted plastic material to flow through the sprue 117, and an extended position (FIG. 5) where a tip of the pin 126 extends through a tip of the sprue 117 in a manner blocking material flow of the melted plastic.

The hot runner apparatus 102 includes an alignment block 130 (FIG. 6) at each outlet secondary nozzle 109, and the mold 103 includes a mating alignment block 131 at each sprue 117. The alignment blocks 130 and 131 are conical/tapered in shape and extend sufficiently to provide an alignment function as the mold 103 is assembled onto the hot runner apparatus 102 and onto the stationary platen of the injection molding machine (i.e., during a mold change). Further, they protect the related components of the secondary nozzles and mating sprues.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. An apparatus comprising:
an injection molding machine having a stationary platen, a movable platen, and a device for injecting melted plastic material through a primary nozzle;
a hot runner apparatus attached to the stationary platen, the hot runner apparatus having an inlet for receiving the melted plastic material from the primary nozzle and having at least two secondary nozzles defining outlets and having at least one elongated passage for communicating the melted plastic material from the primary nozzle to the at least two secondary nozzles; and
a mold with mating mold halves defining a part cavity and defining a passage for communicating the melted plastic material into the cavity, with one of the mold halves further including at least two sprue subassemblies that matably releasably engage associated ones of the secondary nozzles so that the mold can be removed while the hot runner apparatus remains attached to the stationary platen; and
the at least two sprue subassemblies each including a movably-mounted sprue and a stress-reducing mechanism operably supporting the sprue, the stress-reducing mechanism supporting the sprue with sufficient force to prevent leakage of the melted plastic material at abutting surfaces where the sprue engages an associated one of the secondary nozzles, but the stress-reducing mechanism allowing limited movement of the sprue to reduce stress on the sprue when the molding machine is compressively clamping against the mold to hold the mold halves together, the stress-reducing mechanism being designed to provide a strength suitable for causing non-leak abutting contact of the sprues with the associated secondary nozzles.

2. The apparatus defined in claim 1, wherein each of the stress-reducing mechanisms includes a spring washer.

3. The apparatus defined in claim 2, wherein each of the sprues includes an elongated stem and an enlarged end engaged by the secondary nozzle, and the spring washer is positioned around the stem and abuts the enlarged end, biasing the enlarged end toward the secondary nozzle.

4. The apparatus defined in claim 1, including a magnetic plate configured to magnetically hold the one die half on the stationary platen.

5. The apparatus defined in claim 1, including a shut-off pin extending operably into each of the secondary nozzles for controlling flow of the melted plastic material through the respective secondary nozzles.

6. An apparatus adapted for use in an injection molding machine having a stationary platen, a movable platen, and a device for injecting melted plastic material through a primary nozzle; the apparatus comprising:
a hot runner apparatus adapted for attachment to the stationary platen, the hot runner apparatus having an inlet for receiving the melted plastic material from the primary nozzle and having at least two secondary nozzles defining outlets and having at least one elongated passage for communicating the melted plastic material from the primary nozzle to the at least two secondary nozzles; and
at least two molds, each mold having mating mold halves defining a part cavity and defining a passage for communicating the melted plastic material into the cavity, with one of the mold halves further including at least two sprue subassemblies that matably releasably engage the secondary nozzles so that the mold can be removed while the hot runner apparatus remains attached to the stationary platen; and
each of the at least two sprue subassemblies of each mold including a movably-mounted sprue and a stress-reducing mechanism supporting the sprue, the stress-reducing mechanism supporting the respective sprue with sufficient force to prevent leakage of the melted plastic material at abutting surfaces where the sprue engages an associated one of the secondary nozzles, but the stress-reducing mechanism allowing limited movement of the sprue to reduce stress on the sprue when the molding machine is compressively clamping against the mold to hold the mold halves together.

7. The apparatus defined in claim 6, wherein each of the stress-reducing mechanisms includes a spring washer.

8. The apparatus defined in claim 7, wherein each of the sprues includes an elongated stem and an enlarged end engaged by the secondary nozzle, and the spring washer is positioned around the stem and abuts the enlarged end, biasing the enlarged end toward the secondary nozzle.

9. The apparatus defined in claim 8, wherein the at least two molds include a first mold and a second mold, with at least one of the stress-reducing mechanisms in the first mold providing a different level of resistive force than at least one of the stress-reducing mechanisms in the second mold.

10. The apparatus defined in claim 6, wherein the at least two molds include first and second molds that define first and second energy absorbers for a vehicle, the first and second energy absorbers being similar in length and size, but the first energy absorber being configured to provide a different force-deflection curve for absorbing impact energy than the second energy absorber, such that the first energy absorber can be used on a first vehicle model and the second energy absorber can be used on a second vehicle model similar in shape to the first vehicle model but having a different vehicle weight.

11. The apparatus defined in claim 6, wherein the at least two molds include first and second molds that define first and second energy absorbers for a vehicle, the first and second energy absorbers being similar in length and size, but the first energy absorber being made of a different plastic material such that the first energy absorber provides a different force-deflection curve for absorbing impact energy than the second energy absorber, the different plastic material of the first and second energy absorbers having different flow characteristics, such that the first and second molds require different stress-reducing mechanisms.

12. A mold adapted for use in an injection molding machine having a stationary platen, a movable platen, and a device for injecting melted plastic material through a primary nozzle, and having a hot runner apparatus attached to the stationary platen, the hot runner apparatus having an inlet for receiving the melted plastic material from the primary nozzle and having at least two secondary nozzles defining outlets and having at least one elongated passage for communicating the melted plastic material from the primary nozzle to the at least two secondary nozzles; the mold comprising:
mating mold halves defining a part cavity and defining a passage for communicating the melted plastic material into the cavity, with one of the mold halves further including at least two sprue subassemblies that are adapted to matably releasably engage the secondary nozzles so that the mold can be removed while the hot runner apparatus remains attached to the stationary platen; and
the at least two sprue subassemblies each including a movably-mounted sprue and a stress-reducing mechanism supporting the sprue, the stress-reducing mechanism supporting the sprue with sufficient force to prevent leakage of the melted plastic material at abutting surfaces where the sprue engages an associated one of the secondary nozzles, but the stress-reducing mechanism allowing limited movement of the sprue to reduce stress on the sprue when the molding machine is compressively clamping against the mold to hold the mold halves together.

13. The apparatus defined in claim 12, wherein each of the stress-reducing mechanisms includes a spring washer.

14. The apparatus defined in claim 13, wherein each of the sprues includes an elongated stem and an enlarged end engaged by the secondary nozzle, and the spring washer is positioned around the stem and abuts the enlarged end, biasing the enlarged end toward the secondary nozzle.

15. The apparatus defined in claim 14, wherein the stress-reducing mechanisms each include additional spring washers.

16. A method comprising steps of:
providing an injection molding machine having a stationary platen, a movable platen, and a primary nozzle for injecting molten plastic;
providing a hot runner apparatus with an inlet for receiving melted plastic material from the primary nozzle and having a plurality of secondary nozzles for further communicating the melted plastic material;
providing first and second molds each defining a part cavity, a passage to the part cavity, and sprue assemblies for engaging the secondary nozzles to receive the melted plastic material for communication to the part cavity, the sprue assemblies including a movably-mounted sprue and a stress-reducing mechanism supporting the sprue for limited movement;
attaching the hot runner apparatus to the stationary platen;
removably attaching the first mold to the stationary platen with the sprue assemblies of the first mold engaging the secondary nozzles, and with the stress-reducing mechanism in the first mold supporting the movably-mounted sprues with a first amount of force for optimal non-leak abutting contact;
removing the first mold from the injection molding machine while leaving the hot runner apparatus attached to the stationary platen; and
removably attaching the second mold to the stationary platen with the sprue assemblies of the second mold engaging the secondary nozzles, and with the stress-reducing mechanism in the second mold supporting the movably-mounted sprues with a second amount of force for optimal non-leak abutting contact.
